(19) United States
(12) Patent Application Publication
(10) Pub. No.: US 2025/0184651 A1
(43) Pub. Date: Jun. 5, 2025

(54) MULTI-MODE SOUND PERCEPTION HEARING STIMULUS SYSTEM AND METHOD

(71) Applicant: Mayo Foundation for Medical Education and Research, Rochester, MN (US)

(72) Inventors: Michael J. Cevette, Cave Creek, AZ (US); Gaurav N. Pradhan, Fountain Hills, AZ (US)

(21) Appl. No.: 18/839,187

(22) PCT Filed: Feb. 17, 2023
(86) PCT No.: PCT/US2023/013286

§ 371 Date: Aug. 16, 2024

Related U.S. Application Data
(60) Provisional application No. 63/311,310, filed on Feb. 17, 2022.

(51) Int. Cl. H04R 1/10; H04R 5/027; H04R 5/033; H04R 5/04; H04R 25/00

(52) U.S. Cl. CPC H04R 1/1075; H04R 5/027; H04R 5/0335; H04R 5/04; H04R 25/604; H04R 2205/022; H04R 2460/13

(57) ABSTRACT

A multi-mode hearing stimulation method for stimulating the perception of hearing in a subject. The method includes generating, based on sound signals representative of multi-channel sound, two or more of multi-channel electrical stimulation signals, bone conduction stimulation signals, and audio stimulation signals. The electrical stimulation signals are configured to cause electrical stimulation of hearing perception, including lateralization of hearing perception. The bone conduction stimulation signals are configured to produce vibrations causing bone conduction stimulation of hearing perception. The audio stimulation signals are configured to produce air conducted pressure wave sound. Embodiments comprise obtaining compensation information for use in connection with a multi-mode hearing stimulation system. The compensation information may be obtained by concurrently applying the electrical stimulation, bone stimulation or pressure wave sound to the subject, and receiving and storing as compensation information, information representative of a direction from which the subject perceived the resulting perceptions of sound.

### CROSS-REFERENCE TO RELATED APPLICATION

This application is a national phase application of PCT Application No. PCT/US2023/013286, internationally filed on Feb. 17, 2023, which claims the benefit of U.S. Provisional Application No. 63/311,310, filed Feb. 17, 2022, which are herein incorporated by reference in their entireties for all purposes.

### FIELD

This disclosure relates generally to systems and methods for enhancing hearing or sound perception by subjects.

### BACKGROUND

Perception of hearing sound can be provided by electrical stimulation of the cochlea (also sometimes referred to a cochlear stimulation or galvanic vestibular stimulation (GVS)) and by bone conduction stimulation (e.g., through vibration of the skull). Hearing perception of these types may be distinguished from hearing produced by air conducted stimulation or pressure waves that stimulate the ear, which may be enhanced by hearing aids. There remains a continuing need for systems and methods for enhancing the perception of hearing in subjects, including subjects that may have impaired or otherwise constrained audible hearing capabilities.

### SUMMARY

A subject's perception of hearing may be enhanced by combinations of two or more of electrical stimulation, bone conduction stimulation or air conducted stimulation in accordance with embodiments described herein. Applications include human hearing testing and therapeutics, military intelligence (e.g., when communication by air conducted stimulation is not available, used or otherwise impaired or constrained) and entertainment. Capabilities include providing electrically transmitted sound to the head with a full range or hearing from 100 Hz to 20,000 Hz with content including speech, music and movies in real time. In particular, electrical stimulation with any or all other modes of stimulation may provide enhanced lateralization of sound beyond 0 db.

### BRIEF DESCRIPTION OF THE DRAWINGS

FIGS. 1A and 1B are diagrammatic illustrations of headsets including multi-mode stimulation devices located with respect to a head of a user, in accordance with embodiments.

FIG. 2 is a diagrammatic illustration of functional components of a control system for a multi-mode hearing stimulus system, in accordance with embodiments.

FIG. 3 is a diagrammatic illustration of test results showing locations or directions of perceived sound in eleven different subjects in response to combined mono-channel bone conduction stimulation and multi-channel electrical stimulation of the same types when applied to stimulation devices at the same locations with respect to the heads of the different subjects.

FIG. 4 is a diagrammatic illustration of components of the computer system that may be used to implement the control system shown in FIG. 2, in accordance with embodiments.

### DETAILED DESCRIPTION

Multi-mode hearing stimulus systems, methods and components described herein make use of two or more stimulus modalities such as electrical stimulation of the cochlea, bone conduction stimulation, or air conducted stimulation, to provide enhanced sound or hearing perception to subjects or other users. In particular, the multi-mode stimulus systems, methods and components enhance the subject's ability to lateralize and localize the source of the perceived sound (e.g., the location or direction from which the sound originated). The subject's ability to appreciate, enjoy and derive information from the sound, such as for example music, speech or sound in the subject's environment, is thereby enhanced.

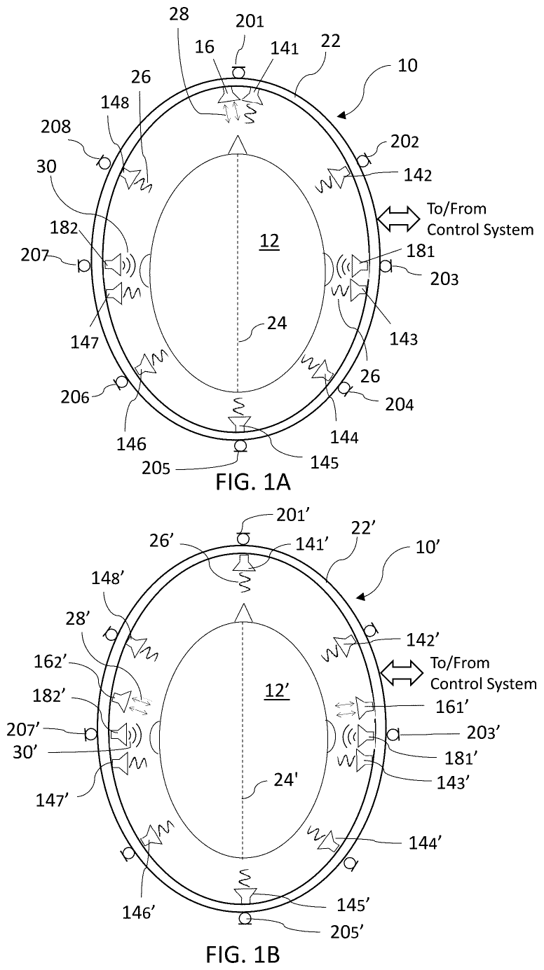

FIG. 1A is a diagrammatic illustration of a structure such as headset 10 including multi-mode stimulation devices and microphones located with respect to a head 12 of a subject in accordance with embodiments. The illustrated embodiments include a plurality (eight are shown for purposes of example) of electrodes 141-148, one bone conduction transducer 16, a plurality (two are shown for purposes of example) of air conducted, pressure wave or audio transducers 181-182, and a plurality (eight are shown for purposes of example) of microphones 201-208, all of which are mounted to a band 22 configured to be attached to or positioned with respect to the head 12 of the subject. Lateralization, or the location or direction of the perceived sound caused by the stimuli produced by the electrodes 141-148, bone conduction transducer 16 and/or audio transducers 181-182, may depend on factors such as the numbers and/or locations of the electrodes, bone conduction transducers or audio transducers. Accordingly, other embodiments include electrodes such as 141-148, bone conduction transducers such as 16 or audio transducers such as 181-182 in other combinations of numbers and/or locations. Similarly, other numbers and/or locations of microphones such as 201-208 may be used in other embodiments. For example, embodiments may include only two electrodes such as 141-148, and in such embodiments the two electrodes may be located near the cochlea of the subject's head 12 (e.g., at the mastoids).

In the embodiments shown in FIG. 1A, for example, electrodes 141-148 are positioned on the band 22 at locations such that they will be located at adjacent positions corresponding to 12:00, 1:30, 3:00, 4:30, 6:00, 7:30, 9:00 and 10:30, respectively, on the head 12 of the subject. Electrodes 143 and 147 may be located at positions adjacent the right and left mastoids of the head 12 of the subject to optimize or otherwise enhance the ability of electrical stimulation provided by the electrodes to stimulate the right and left cochlea, respectively, of the subject. Electrodes 141 and 145 are shown located at positions that will be adjacent the anterior and posterior portions of the subject's head 12 (e.g., at the ends of a medial midline 24 through the subject's head). As described in greater detail below, electrodes 141-148 produce electrical signals (shown diagrammatically at 26 in FIG. 1A) that stimulate the cochlea of the subject to cause the perception of hearing. Electrodes 141-148 may be conventional or otherwise known devices suitable for the functions and applications described herein. Nonlimiting examples include surface electrodes typically used for stimulation and recording of electrical signals. Although described as devices that provide transcutaneous electrical stimulation in this disclosure, it will be appreciated that electrodes such as 141-148 may be utilized in devices in other embodiments.

Bone conduction transducer 16 is shown located at a position that will be adjacent the anterior portion of the subject's head 12 (e.g., on the subject's forehead at the medial midline 24). As described in greater detail below, bone conduction transducer 16 produces physical movement or other vibratory actions (shown diagrammatically at 28 in FIG. 1A) that vibrate the skull and/or other anatomical structures of the subject's head 12 to stimulate and cause the perception of hearing. Bone conduction transducer 16 may be conventional or otherwise known devices suitable for the functions and applications described herein. Nonlimiting examples include devices producing mechanical oscillation or vibration.

Audio transducers 181-182 produce audible and air conducted pressure waves (shown diagrammatically at 30 in FIG. 1A) that vibrate the eardrum, tympanic membrane and/or other anatomical structures of the ear or auditory system in the subject's head 12 to produce hearing or the perception of hearing. The audio transducers 181-182 may be located at positions adjacent the ear canals of the subject to optimize the hearing they produce. Audio transducers 181-182 may be conventional or otherwise known devices suitable for the functions and applications described herein. Nonlimiting examples include audio speakers, such as for example of the types used in hearing aids.

Microphones 201-208 are located on the band 22 such that they may be located adjacent positions corresponding to 12:00, 1:30, 3:00, 4:30, 6:00, 7:30, 9:00 and 10:30, respectively on the head 12 of the subject. The microphones 201-208 may be positioned, oriented or otherwise configured (e.g., structured to have directional characteristics) to receive sound from defined directions or locations with respect the head 12 of the subject. Microphones 201-208 may be conventional or otherwise known devices suitable for the functions and applications described herein.

FIG. 1B is a diagrammatic illustration of exemplary alternative embodiments of a headset 10′. As shown, headset 10′ includes a plurality electrodes 141′-148′, two bone conduction transducers 161′ and 162′, a plurality of audio transducers 181′-182′, and a plurality of microphones 201′-208′, all of which are mounted to a band 22′ configured to be attached to or positioned with respect to the head 12 of the subject. In the embodiments shown in FIG. 1B, the two bone conduction transducers 161′ and 162′ are shown located at positions on the band 22′ such that they will be located adjacent positions corresponding to 3:00 and 2:00, respectively on the head 12 of the subject. Other than these different numbers and locations of the bone conduction transducers 161′ and 162′, headset 10′, including the electrodes 141′-148′, audio transducers 181′-182′ and microphones 201′-208′, may be the same as or similar to, and located at or adjacent positions that are the same as or similar to, those described in connection with FIG. 1A. Similar reference numbers are used to indicate similar features in FIGS. 1A and 1B. Throughout this disclosure the term “stimulation devices” may be used to refer to one or more, or all, of stimulation devices, such as for example one or more the stimulation devices 141-148, 141′-148′, 16, 161′, 162′, 181-182, or 181′-182′.

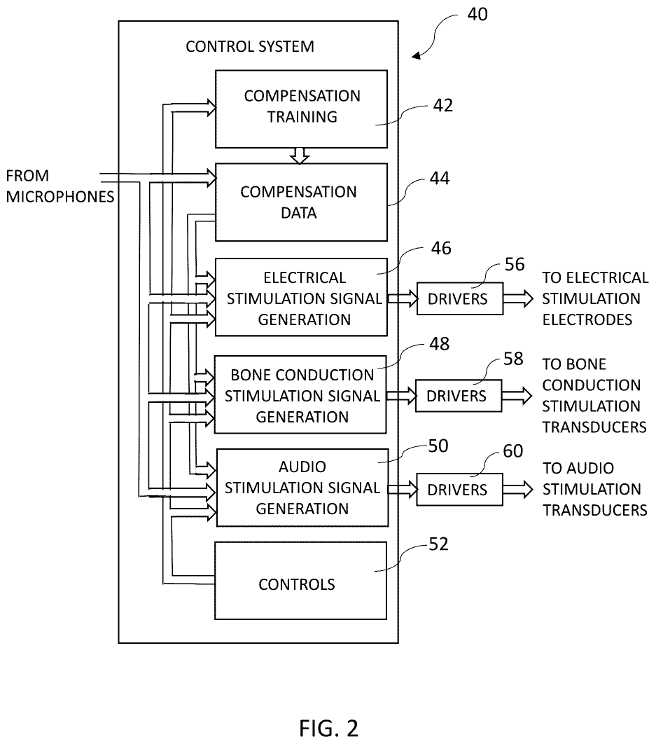

FIG. 2 is a diagrammatic illustration of functional components of a control system 40 that can be used in connection with stimulation devices such as those described above in connection with FIGS. 1A and 1B to provide multi-mode hearing perception stimulation to a subject, in accordance with embodiments. The illustrated embodiments of control system 40 include compensation training component 42, compensation data component 44, electrical stimulation generation component 46, bone conduction stimulation generation component 48, air conducted stimulation generation component 50 and operator controls 52. Throughout this disclosure the term “stimulation generation components” may be used to refer to one or more, or all, of stimulation signal generation components such as electrical stimulation generation component 46, bone conduction stimulation generation component 48 or audio stimulation generation component 50. Multi-channel sound signals representative of or defining multi-channel sound, such as for example sound produced by microphones 201-208 or 201′-208′, are coupled to an input of the control system 40 and to various components of the control system. In the embodiments shown in FIG. 2, for example, sound signals representative of one or more of the multiple channels of sound are coupled to each of the compensation data component 44, electrical stimulation generation component 46, bone conduction stimulation generation component 48, and audio stimulation generation component 50. Although the multi-channel sound signals are described as being received from the microphones 201-208 or 201′-208′ in this disclosure (e.g., are representative of the sound in the surroundings or local environment of the subject using the headset 10 or 10′), it is contemplated that the multi-channel sound signals may be received from other sources. Nonlimiting examples of such other sources include sources of sound remote from the subject but being produced in real-time with the stimulus provided by the control system 40 (e.g., sound from an event the subject is viewing from a distance either live or through media such as a video screen) and/or recorded sound (e.g., sound provided in connection with video or other media). In such other embodiments, for example, the headsets 10 and 10′ may not include microphones 201-208 or 201′-208′

As described in greater detail below, certain embodiments of the control system 40 use compensation data in connection with the generation of the multi-mode stimuli to enhance the perceptibility, such as for example the lateralization qualities or characteristics, of the sound or hearing produced by the system. Briefly, the compensation data controls or modifies aspects by which the sound represented by the multi-channel sound signals is effectively mapped or distributed to the multi-mode stimulation devices. Examples include compensation to control levels of perceived hearing (e.g., if the subject has asymmetrical directional hearing level perception characteristics) and to control directional lateralization (e.g., if the subject perceives sound as coming from directions different than the directions of the corresponding channels of the sound). The compensation data, which may be stored in compensation data component 44, is coupled to one or more of the electrical stimulation generation component 46, bone conduction stimulation generation component 48, or audio stimulation generation component 50. As described in greater detail below, compensation training component 42 can be used in connection with a compensation training process to generate the compensation data stored by compensation data component 44. Although shown as part of the control system 40 in the embodiments of FIG. 2, compensation training component 42 may be separate from the control system 40 in other embodiments, and the compensation data produced by the separate compensation training component 44 may be imported into the compensation data component in such embodiments.

Controls 52 may include conventional or otherwise known interface components used by an operator to operate the control system 40 and perform the functions described herein. Nonlimiting examples includes knobs, buttons, switches or graphical user interface (GUI) components, including displays, such as for example to select functions and information, to control levels, and to provide information (e.g., visually) to a clinician or other user.

Electrical stimulation generation component 46 generates multi-channel electrical stimulation signals based on the multi-channel sound signals. In embodiments, the electrical stimulation signal generation component 46 generates the multi-channel electrical stimulation signals based on both the multi-channel sound signals and the compensation data. The multi-channel electrical stimulation signals are configured to be coupled to two or more of the electrodes such as 141-148 or 141′-148′. Electrical stimulation generation component 46 produces the electrical stimulation signals in forms and having characteristics configured to cause the electrodes to electrically stimulate the cochlea in the head 12 of the subject, and thereby the perception of sound or hearing in the subject.

The multi-channel stimulation provided by the electrical stimulation generation component 46 provides lateralization (e.g., directional) hearing perception in the user. In particular, the multi-channel electrical stimulation signals have forms and characteristics (e.g., levels and phases), and are applied to specific electrodes, that cause the hearing to be perceived as originating from specific locations or directions around the head 12 of the subject (e.g., at 12:00, 3:00, 6:00 and/or 9:00 positions, above, below, or other locations or directions with respect to a sphere about the head 12 of the subject). For example, electrical generation component 46 may generate multi-channel electrical stimulation signals based on multi-channel sound signals received from two or more of microphones 201-208 or two or more of microphones 201′-208′, that are applied to two or more of the electrodes such as 141-148 or two or more of the electrodes 141′-148′, in such a manner that the sound perceived by the subject based on the electrical stimulation is perceived to originate from locations corresponding to the locations and/or at levels of the sound received by the microphones.

Electrical stimulation generation component 46 can be configured to produce the electrical simulation signals by conventional or otherwise known approaches. Electrical stimulation approaches of these types are also sometimes referred to as galvanic vestibular stimulation (GVS) or cochlear stimulation. For example, the Puharich U.S. Pat. No. 3,267,931, Zink U.S. Pat. No. 3,766,331 and Tonndorf et al. article entitled High Frequency Audiometry published in 1984 describe approaches for modulating carrier signals to produce electrical stimulation signals that, when applied to the cochlea through electrodes, will produce electrical signals causing stimulation of hearing perception. The Puharich and Zink patents and the Tonndorf et al. article are hereby incorporated by reference and for all purposes. Electrical stimulation modalities of these types are generally capable of stimulating perceived sound over a relatively wide range of frequencies corresponding to much or all of the full range of typical hearing, such as 100 Hz to 20,000 Hz.

Embodiments of bone conduction stimulation generation component 48 generate mono-channel or single-channel bone conduction stimulation signals based on one or more channels of the multi-channel sound defined by the multi-channel sound signals. In embodiments, the bone conduction stimulation generation component 48 generates the mono-channel bone conduction stimulation signals based on both the sound signals and the compensation data. When used in connection with a headset such as 10, for example, the mono-channel bone conduction stimulation signals are configured to be coupled to the bone conduction transducer 16. When used in connection with a headset such as 10′, for example, the mono-channel bone conduction stimulation signals are configured to be coupled to one or both of the bone conduction transducers 161′ and 162′. Bone conduction stimulation generation component 48 produces the bone conduction stimulation signals in forms and having characteristics configured to cause the bone conduction transducers to vibrate the skull of the head 12 of the subject, and thereby cause the perception of hearing in the subject. Bone conduction stimulation of the subject provided by bone conduction stimulation signals produced by the bone conduction stimulation generation component 48, when provided concurrently with (e.g., at the same time as or otherwise in combination with) one or both of the multi-channel electrical stimulation produced through the electrical stimulation generation component 46 or the audio stimulation produced through the audio stimulation generation component 50 enhances the overall perception of sound by the subject, including lateralization of the perceived sound.

Embodiments of bone conduction stimulation generation component 48 generate multi-channel bone conduction stimulation signals based on two or more channels of the multi-channel sound defined by the multi-channel sound signals. In embodiments, the bone conduction stimulation generation component 48 generates the multi-channel bone conduction stimulation signals based on both the multi-channel sound signals and the compensation data. When used in connection with a headset such as 10′, for example, the multi-channel bone conduction stimulation signals are configured to be coupled to the bone conduction transducers 161′ and 162′. Bone conduction stimulation generation component 48 produces the bone conduction stimulation signals in forms and having characteristics configured to cause the bone conduction transducers to vibrate the skull of the head 12 of the subject, and thereby cause the perception of hearing in the subject.

The multi-channel stimulation provided by the bone conduction stimulation generation component 48 may provide lateralization hearing perception in the subject. In particular, the multi-channel bone conduction stimulation signals have forms and characteristics, and are applied to specific transducers, that cause the hearing to be perceived as originating from specific locations or directions around the head 12 of the subject (e.g., at 12:00, 3:00, 6:00 and/or 9:00 positions, above, below, or other locations or directions with respect to a sphere about the head 12 of the subject). For example, bone conduction generation component 48 may generate multi-channel bone conduction stimulation signals based on multi-channel sound signals received from two or more of microphones 201′-208′, and that are applied to transducers such as 161′ and 162′, in such a manner that the sound perceived by the subject based on the bone stimulation is perceived to originate from locations or directions, and at levels, corresponding to the locations, directions or levels of the sound received by the microphones. In at least some instances it has been observed that lateralization (e.g., directional and level) capabilities provided by the multi-channel bone conduction stimulation may be less than the capabilities provided by electrical stimulation or audio stimulation modalities. However, multi-channel bone conduction stimulation of the subject provided by bone conduction stimulation signals produced by the bone conduction stimulation generation component 48, when provided concurrently or otherwise in combination with one or both of the multi-channel electrical stimulation produced through the electrical stimulation generation component 46 or the audio stimulation produced through the audio stimulation generation component 50, enhances the overall perception of sound by the subject, including lateralization of the perceived sound.

Bone conduction stimulation generation component 48 can be configured to produce the bone conduction stimulation signals by conventional or otherwise known approaches. For example, the bone conduction stimulation signals may have varying frequencies corresponding to or representative of the desired sound perception to be provided to the subject. The bone conduction stimulation signals may be amplitude modulated or frequency modulated and/or phased in embodiments. The following articles, for example, describe various bone conduction stimulation approaches that may be used in connection with bone conduction stimulation generation component 48, and are incorporated herein in their entireties and for all purposes: Shiraishi, K., Sound Localization and Lateralization by Bilateral Bone Conduction Devices, Middle Ear Implants and Cartilage Conduction Hearing Aids, Audiology Research 2021, 11, 508-523; Stanley, R. et al., Lateralization of Sounds Using Bone-Conducted Headsets, Proceedings of the Human Factors and Ergonomics Society 50th Annual Meeting 2006; Bone-Conducted Sound Lateralization of Interaural Time Difference and Interaural Intensity Difference in Children and a Young Adult with Bilateral Microtia and Atresia of the Ears, Daga, K. et al., Acta Otolaryngol. 2001, 121, 274-277. Bone conduction stimulation modalities of these types are typically capable of providing perception of hearing over frequency ranges below the upper ranges of those provided by electrical stimulation modalities. For example, the most effective frequency ranges of bone conduction stimulation in certain subjects may typically range from about 250 Hz to about 6,000 Hz.

Embodiments of audio stimulation generation component 50 generate mono-channel air conducted stimulation signals based on one or more channels of the multi-channel sound defined by the multi-channel sound signals. In embodiments, the audio stimulation generation component 50 generates the mono-channel audio stimulation signals based on both the sound signals and the compensation data. In certain embodiments the audio stimulation generation component 50 generates multi-channel audio stimulation signals based on multiple channels of the sound defined by the multi-channel sound signals. In embodiments, the audio stimulation generation component 50 generates the multi-channel audio stimulation signals based on both the sound signals and the compensation data. When used in connection with headsets such as 10 or 10′, for example, the mono-channel or multi-channel audio stimulation signals are configured to be coupled to one or both of the audio transducers 181-182, or one or both of the audio transducers 181′-182′. Audio stimulation generation component 50 produces the audio stimulation signals in forms and having characteristics configured to cause the audio transducers 181-182 or 181′-182′ to produce audible sound via air conducted pressure waves, and thereby hearing in the subject. Audio stimulation of the subject provided by audio stimulation signals produced by the audio stimulation generation component 50, when provided concurrently with or otherwise at the same time as one or both of the multi-channel electrical stimulation produced through the electrical stimulation generation component 46 or mono-channel or multi-channel bone conduction stimulation produced through the bone conduction stimulation generation component 48 enhances the overall perception of sound by the subject.

Multi-channel stimulation provided by the audio stimulation generator 50 may provide lateralization hearing perception in the user. In particular, the multi-channel audio stimulation signals have forms and characteristics, and are applied to specific audio transducers, that cause the hearing to be perceived as originating from specific locations or directions around the head 12 of the subject (e.g., at 12:00, 3:00, 6:00 and/or 9:00 positions, above, below, or other locations or directions with respect to a sphere about the head 12 of the subject). For example, audio stimulation generation component 50 may generate multi-channel audio stimulation signals based on multi-channel sound signals received from two or more of microphones 201-208 or 201′-208′, that are applied to transducers such as 181 and 182 or 181′ and 182′, in such a manner that the sound perceived by the subject based on the audio stimulation is perceived to originate from locations or directions and/or at levels corresponding to the locations, directions and/or levels of the sound received by the microphones.

Audio stimulation generation component 50 can be configured to produce the audio stimulation signals by conventional or otherwise known approaches. For example, the audio stimulation signals may be frequency modulated and/or amplitude modulated and/or phased in a manner that corresponds to the frequencies and/or levels of the desired sound perception to be provided to the subject. Nonlimiting examples include approaches used by conventional or otherwise known hearing aids. Audio stimulation modalities of these types are typically capable of stimulating perceived sound over a relatively wide range of frequencies corresponding to much or all of the full range of typical hearing, such as 100 Hz to 20,000 Hz.

The embodiments of the control system 40 shown in FIG. 2 include drivers 56, 58 and 60 coupling the electrical stimulation generation component 46, bone conduction stimulation generation component 48 and audio stimulation generation component 50, respectively, to the associated stimulation devices such as electrical stimulation electrodes 141-148 or 141′-148′, bone conduction stimulation transducers 16 or 161′ or 162′, or audio stimulation transducers 181-182 or 181′-182′. Drivers 56, 58 or 60 convert the signals produced by the respective signal generation components 46, 48 or 50 to levels suitable for application to the associated stimulation devices. In embodiments, for example, drivers 56, 58 or 60 may include transformers or other components to convert the signals produced by the respective stimulation generation components 46, 48 or 50 to current and/or voltage levels and/or impedance levels suitable for application to the stimulation devices.

The compensation that may be provided by the signal generation components 46, 48 and/or 50 corrects (e.g., at least partially) for variations in characteristics of the perceived hearing of the subject. For example, for one individual subject, stimulation at one given level applied to one or more of the stimulation devices on one side (e.g., the right side) of the subject may produce perceived hearing at different levels (e.g., volumes) than stimulation at that one given level when applied to one or more of the stimulation devices on the other side (e.g., the left side) of the subject. Similarly, such asymmetrical level perceptions may vary between different subjects. Compensation data stored by compensation data component 44 may be used by the signal generation components 46, 48 or 50 to account for these differences, so the levels of the perceived hearing correlates to the “desired” levels, for example as represented by the sound signals input to the control system 40. As other example, stimulation of one given type applied to one or more specific stimulation devices on a first subject may be perceived as originating from a first location or direction, while that simulation of the one given type applied to the same or similar one or more specific stimulation devices in another, second subject may be perceived as originating from a second location or direction different than the first location or direction in the first subject. Compensation data stored by compensation data component 44 may be used by the signal generation components 46, 48 or 50 to account for these differences, so the locations or directions of the perceived hearing correlates to the “desired” locations or directions, for example the locations or directions represented by the sound signals input to the control system 40. In embodiments, for example, the compensation data of compensation data component 44 is used by the signal generation components 46, 48 or 50 to map, translate or correlate sound information (e.g., locations, direction of levels) defined by the multi-channel sound signals to stimuli generated by the signal generation components that will produce perceived sound or hearing corresponding to the sound information in the multi-channel sound signals.

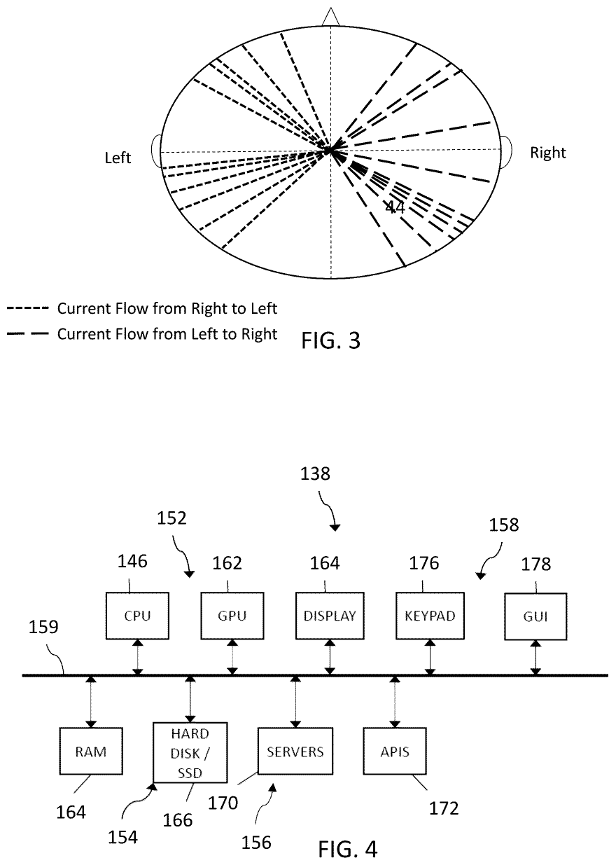

As an example, FIG. 3 is a diagrammatic illustration of varying locations or directions (e.g., angles) of perceived sound in eleven different subjects in response to combined mono-channel bone conduction stimulation and multi-channel electrical stimulation of the same types when applied to stimulation devices at the same locations with respect to the heads of the different subjects. The results shown in FIG. 3 were produced using mono-channel bone conduction stimulation applied to bone conduction transducers located adjacent the foreheads of the subjects, at the anterior locations on the medial midlines, and electrical stimulation applied to electrodes located adjacent the right and left mastoids of the subjects. For the electrical stimulation, the signals were applied to the right and left electrodes in both right to left current flow directions (anodes to cathodes), which produced sound perception on the left side for all subjects, and left to right current flow directions, which produced sound perception on the right sides for all subjects. As shown in FIG. 3, the same stimulation resulted in perceptions of different source directions or locations on each the different right and left sides of the median midline, with the different directions including directions on both anterior and posterior sides of a coronal midline. In general, when the bone conduction stimulation was applied alone, the subjects perceived resulting hearing as being located at various locations within an area generally centrally located between the anterior, posterior, right and left sides of the heads. When the electrical stimulation was applied alone in the right to left directions, the subjects perceived the hearing as being located at various locations on the left sides of the heads. When the electrical stimulation was applied alone in the left to right directions, the subjects perceived the hearing as being located at various locations on the right sides of the heads.

A protocol used to produce the information shown in FIG. 3 included stimulation configured to produce the perception of hearing at three different frequencies (2000 Hz, 4000 Hz and 8000 Hz). At each of the frequencies, the bone conduction stimulation was provided separately (e.g., without electrical stimulation) at varying levels to determine the lowest or threshold level at which the subject could perceive the stimulation (e.g., the subjects told the clinicians when they could perceive the hearing). Threshold bone conduction stimulation levels were thereby determined at each of the frequencies for each subject. At each of the frequencies, the electrical stimulation was provided separately (e.g., without bone conduction stimulation) at varying levels in a right to left current flow direction to determine the lowest or threshold level at which the subject could perceive the stimulation (e.g., the subjects told the clinicians when they could perceive the hearing). Similarly, at each of the frequencies, the electrical stimulation was provided separately at varying levels in a left to right current flow direction to determine the lowest or threshold level at which the subject could perceive the stimulation. Threshold electrical stimulation levels were thereby determined at each of the frequencies, and for both current flow directions, for each subject. Lateralization determinations were then made for each of the subjects at each of the frequencies using concurrent bone conduction and right to left current flow direction electrical stimulation, and concurrent bone conduction and left to right current flow direction electrical stimulation, at levels a predetermined amount, such as for example+10 dB, above the established thresholds. During these determinations the subjects told the clinicians the locations or directions at which they perceived the hearing.

Methods such as those described above can be performed using the compensation training component 42 of the control system 40 to obtain the compensation data for individual subjects. For example, a clinician can use the controls 52, which may for example include a display, to cause the stimuli to be applied to subjects at each of the stimulation devices at each of a plurality of characteristics to cause perceived hearing at a plurality of different frequencies. Threshold levels can then be determined for each of the stimulation devices for each frequency. A clinician can use the controls 52 to cause stimuli to be applied to subjects at each of the stimulation devices at each of a plurality of characteristics (e.g., current flow directions in the case of the electrical stimulation devices) to cause perceived hearing at a plurality of different frequencies. Locations or directions can then be determined for each of the stimulation devices for each frequency. Compensation data may be specific for individual subjects. Additionally or alternatively, the compensation data may correspond to averages of characteristics of groups of subjects.

The stimulation generation devices may then generate the stimulation signals based on the multi-channel sound signals and the compensation data so that the stimulation signals, when applied to the stimulation devices, will cause the perceived sound to have desired characteristics such as location or direction and/or levels. In embodiments, for example, the stimulation generation devices may generate the stimulation signals based on multi-channel sound signals received by the microphones 201-208 or 201′-208′ in such a manner that the sound perceived by the subject corresponds to the locations, directions and levels defined by the multi-channel sound signals. In embodiments, for example, the multi-channel sound signals may be effectively summed and/or otherwise processed with the compensation date to produce the stimulation signals having the desired perceived hearing effects.

FIG. 4 is a diagrammatic illustration of an exemplary computer system 138 that may be used to implement the functional components of the control system 40, including the compensation training component 42, compensation data component 44, electrical stimulation generation component 46, bone conduction stimulation generation component 48, audio stimulation generation component 50 and operator controls 52, in accordance with embodiments. The illustrated embodiments of computer system 138 comprise processing components 152, storage components 154, network interface components 156 and user interface components 158 coupled by a system network or bus 159. Processing components 152 may, for example, include central processing unit (CPU) 160 and graphics processing unit (GPU) 162, and provide the processing functionality for the stimulation generation components. The storage components 154 may include RAM memory 164 and hard disk/SSD memory 166, and provide the storage functionality of the compensation data component 44. For example, operating system software used by the processing components 152 to implement methods described herein may be stored by the storage components 154. In embodiments, the network interface components may include one or more web servers 170 and one or more application programming interfaces (APIs) 172. Examples of user interface components 158 include display 174, keypad 176 and graphical user interface (GUI) 178. Embodiments of computer system 138 may include other conventional or otherwise known components to implement the methods in accordance with embodiments described herein.

A first example includes a system having a headset and a control system. Embodiments include a multi-mode hearing stimulation system, comprising: a sound signal input configured to receive sound signals representative of multi-channel sound; at least two electrical stimulation electrodes (e.g., including an anode and cathode pair) configured to be positioned at spaced-apart locations with respect to a head of a subject; at least one bone conduction stimulation transducer configured to be positioned with respect to the head of the subject; and a control system including at least one processor coupled to the sound signal input, the at least two electrical stimulation electrodes and the at least one bone conduction stimulation transducer, wherein the control system produces (1) multi-channel electrical stimulation signals configured to produce electrical signals by the at least two electrical stimulation electrodes causing stimulation of hearing perception, including lateralization of hearing perception, in the subject based on the sound signals, and (2) bone conduction stimulation signals configured to produce vibrations by the at least one bone conduction stimulation transducer causing stimulation of hearing perception in the subject based on the sound signals.

In embodiments of the first example, the control system produces the multi-channel electrical stimulation signals including one or both of level or phase differences. In any or all of these embodiments, the at least two electrical stimulation electrodes include first and second electrodes configured to be positioned adjacent right and left mastoids, respectively, of the subject (e.g., at 3:00 and 9:00 positions with respect to the head of the subject). Embodiments may further include first and second microphones coupled to the sound signal input, wherein the first and second microphones are configured to be positioned adjacent right and left mastoids, respectively, of the subject (e.g., at 3:00 and 9:00 positions with respect to the head of the subject).

In any or all embodiments of the first example, the at least two electrical stimulation electrodes include two electrodes configured to be positioned at 12:00 and 6:00 positions, respectively, with respect to the head of the subject. Embodiments may further include two microphones coupled to the sound signal input and configured to be positioned at 12:00 and 6:00 positions, respectively, with respect to the head of the subject.

In any or all embodiments of the first example, the at least two electrical stimulation electrodes include two electrodes configured to be positioned at 1:30 and 7:30 positions, respectively, with respect to the head of the subject. Embodiments may further include two microphones coupled to the sound signal input and configured to be positioned at 1:30 and 7:30 positions, respectively, with respect to the head of the subject.

In any or all embodiments of the first example, the at least two electrical stimulation electrodes include two electrodes configured to be positioned at 4:30 and 10:30 positions, respectively, with respect to the head of the subject. Embodiments may further include two microphones coupled to the sound signal input and configured to be positioned at 4:30 and 10:30 positions, respectively, with respect to the head of the subject.

In any or all embodiments of the first example, the at least one bone conduction transducer is configured to be positioned along a median midline with respect to the head of the subject.

In any or all embodiments of the first example, the at least one bone conduction stimulation transducer includes first and second bone conduction stimulation transducers configured to be positioned at spaced-apart locations with respect to the head of the subject; and the control system produces multi-channel bone conduction stimulation signals configured to produce vibrations by the first and second bone conduction stimulation transducers causing stimulation of hearing perception, including lateralization of hearing perception, in the subject based on the sound signals. In embodiments, the first and second bone conduction stimulation transducers are configured to be positioned on opposite sides of a median midline with respect to the head of the subject.

In any or all embodiments of the first example, the control system produces the multi-channel bone conduction signals including one or both of level or phase differences.

Any or all embodiments of the first example may further comprise a mounting structure, optionally a headband, configured to be mounted to the head of the subject, and wherein the at least two electrical stimulation electrodes and the at least one bone conduction stimulation transducer are coupled to the mounting structure.

In any or all embodiments of the first example, the control system (1) causes the multi-channel electrical stimulation signals to produce electrical signals causing stimulation of hearing at frequencies greater than or equal to 8 KHz, and optionally greater than or equal to 15 KHz, and (2) causes the bone conduction stimulation signals to produce vibrations causing stimulation of hearing at frequencies less than 8 KHz.

In any or all embodiments of the first example, the control system causes the multi-channel electrical stimulation signals to produce electrical signals causing stimulation of hearing at a range of frequencies including frequencies greater than a range of frequencies of the hearing caused by the vibrations produced by the bone conduction stimulation signals.

In any or all embodiments of the first example, the control system further includes memory storing compensation information characterizing one or both of location and level of sound perception of the subject based on one or more of (1) characteristics of the multi-channel electrical stimulation signals, or (2) which of the at least two electrical stimulation electrodes the multi-channel electrical stimulation signals are coupled to, (3) characteristics of the bone conduction stimulation signals, or (4) which of the at least one bone conduction stimulation transducer the bone conduction stimulation signals are coupled to; and the control system produces one or both of (1) multi-channel electrical stimulation signals based on the sound signals and the compensation information, or (2) bone conduction stimulation signals based on the sound signals and the compensation information.

In any or all embodiments of the first example, the system further comprises one or two audio transducers, each audio transducer configured to be positioned with respect to an ear on the head of the user; and the control system is coupled to the one or two audio transducers, and produces multi-channel audio stimulation signals configured to produce air conducted pressure wave sound by the one or two audio transducers, including lateralization of the audible sound, based on the sound signals received at the sound signal input.

A second example is a programmed control system without a headset. Embodiments of the second example include a control system programmed to provide the functions of the control system of any or all embodiments of the first example (e.g., exclusive of other components such as the one or more electrical stimulation electrodes, the at least one bone conduction stimulation transducer, the microphones, the one or two audio transducers, and the mounting structure).

A third example is software for a control system. Embodiments of the third example include a non-transitory information storage medium including programmed instructions to cause a control system to perform the functions of any embodiments of the control system of the first example.

A fourth example is a method for stimulating hearing perception. Embodiments of the fourth example include a method for stimulating the perception of hearing in a subject, comprising: receiving sound signals representative of multi-channel sound; generating multi-channel electrical stimulation signals based on the sound signals configured to produce electrical signals causing stimulation of hearing perception in a subject, including lateralization of hearing perception, when coupled to at least two electrical stimulation electrodes (e.g., including an anode and cathode pair) positioned at spaced-apart locations with respect to a head of the subject; generating bone conduction stimulation signals based on the sound signals configured to produce vibrations causing stimulation of hearing perception in the subject, when coupled to at least one bone conduction stimulation transducer positioned with respect to the head of the subject.

In embodiments of the fourth example, generating the multi-channel electrical stimulation signals comprises generating the multi-channel electrical stimulation signals including one or both of level or phase differences.

In any or all embodiments of the fourth example, generating the multi-channel electrical stimulation signals comprises generating signals configured for first and second electrodes positioned adjacent right and left mastoids, respectively, of the subject (e.g., at 3:00 and 9:00 positions with respect to the head of the subject). In embodiments, receiving the sound signals comprises receiving signals representative of multi-channel sound from first and second microphones positioned adjacent right and left mastoids, respectively, of the subject (e.g., at 3:00 and 9:00 positions with respect to the head of the subject).

Any or all embodiments of the fourth example may further include generating the multi-channel electrical stimulation signals configured for at least two electrical stimulation electrodes positioned at 12:00 and 6:00 positions, respectively, with respect to the head of the subject. In embodiments, receiving the sound signals comprises receiving signals representative of multi-channel sound from two microphones positioned at 12:00 and 6:00 positions, respectively, with respect to the head of the subject.

Any or all embodiments of the fourth example may further include generating the multi-channel electrical stimulation signals configured for at least two electrical stimulation electrodes positioned at 1:30 and 7:30 positions, respectively, with respect to the head of the subject. In embodiments, receiving the sound signals comprises receiving signals representative of multi-channel sound from two microphones positioned at 1:30 and 7:30 positions, respectively, with respect to the head of the subject.

Embodiments of the fourth example may include generating the multi-channel electrical stimulation signals configured for at least two electrical stimulation electrodes positioned at 4:30 and 10:30 positions, respectively, with respect to the head of the subject. In embodiments, receiving the sound signals comprises receiving signals representative of multi-channel sound from two microphones positioned at 4:30 and 10:30 positions, respectively, with respect to the head of the subject.

In any or all embodiments of the fourth example, generating the bone conduction stimulation signals comprises generating bone conduction stimulation signals configured for a bone conduction transducer positioned along a median midline with respect to the head of the subject.

In any or all embodiments of the fourth example, generating the bone conduction stimulation signals comprises generating multi-channel bone conduction stimulation signals configured to produce vibrations by the bone conduction stimulation transducer causing stimulation of hearing perception, including lateralization of hearing perception in the subject, based on the sound signals. In embodiments, generating the multi-channel bone conduction stimulation signals comprises generating multi-channel bone conduction stimulation signals configured to produce vibrations by first and second bone conduction stimulation transducers positioned on opposite sides of a median midline with respect to the head of the subject. In some embodiments, generating the multi-channel bone conduction signals includes generating multi-channel bone conduction signals including one or both of level or phase differences.

In any or all embodiments of the fourth example, (1) generating the electrical stimulation signals includes generating multi-channel electrical stimulation signals to produce electrical signals causing stimulation of hearing at frequencies greater than or equal to 8 KHz, and (2) generating the bone conduction stimulation signals includes generating bone conduction stimulation signals to produce vibrations causing stimulation of hearing at frequencies less than 8 KHz.

Any or all embodiments of the fourth example may include generating the multi-channel electrical stimulation signals to produce electrical signals causing stimulation of hearing at a range of frequencies including frequencies greater than a range of frequencies of the hearing caused by the vibrations produced by the bone conduction stimulation signals.

In any or all embodiments of the fourth example, one or both of (1) generating the multi-channel electrical stimulation signals includes generating the multi-channel electrical stimulation signals based on the sound signals and electrical stimulation lateralization compensation information, wherein the electrical stimulation lateralization compensation information includes information characterizing one or both of location or level of sound perception of the subject based on one or more of (i) characteristics of the multi-channel electrical stimulation signals, or (ii) which of the at least two electrical stimulation electrodes the multi-channel electrical stimulation signals are coupled to, or (2) generating the bone conduction stimulation signals includes generating the bone conduction stimulation signals based on the sound signals and bone conduction lateralization compensation information, wherein the bone conduction lateralization compensation information includes information characterizing one or both of location or level of sound perception of the subject based on one or more of (iii) characteristics of the bone conduction stimulation signals, or (iv) which of the at least one bone conduction stimulation transducer the bone conduction stimulation signals are coupled to.

A fifth example is a programmed control system. Embodiments of the fifth example include a control system programmed to perform the method of any or all of the embodiments of the fourth example.

A sixth example is software. Embodiments of the sixth example include a non-transitory information storage medium including programmed instructions to cause one or more processors to perform the methods of any or all of the embodiments of the fourth example.

A seventh example is a compensation training method. Embodiments of the seventh example include a method for generating compensation information for use in connection with a multi-mode hearing stimulation system including a bone conduction stimulation transducer positioned with respect to a head of a subject and at least two electrical stimulation electrodes (e.g., including a cathode and anode pair) positioned at spaced apart locations with respect to the head of the user, comprising: concurrently applying bone conduction stimulation and electrical stimulation to the subject; receiving, and storing as compensation information, information representative of a direction from which the subject perceives the perception of sound produced by the bone conduction stimulation and the electrical stimulation.

In embodiments of the seventh example, concurrently applying bone conduction stimulation and electrical stimulation comprises providing bone conduction stimulation and electrical stimulation representative of sound perception at a first frequency. In embodiments, concurrently applying bone conduction stimulation and electrical stimulation comprises providing bone conduction stimulation and electrical stimulation representative of sound perception at each of a plurality of frequencies; and receiving and storing as compensation information comprises receiving, and storing as compensation information, information representative of a direction in which the subject perceives the perception of sound produced by the bone conduction stimulation and the electrical stimulation at each of the plurality of frequencies.

In any or all embodiments of the seventh example, applying the electrical stimulation comprises applying the electrical stimulation in both a first direction and a second direction between the at least two electrical stimulation electrodes at each frequency; and receiving and storing as compensation information comprises receiving, and storing as compensation information, information representative of a direction the subject perceives the perception of sound produced by the electrical stimulation in both the first direction and the second direction at each frequency.

Any or all embodiments of the seventh example may further comprise applying bone conduction stimulation to the subject at a range of levels; receiving, and storing as compensation information, a bone conduction threshold level representative of a threshold level of the bone conduction stimulation at which the subject perceives sound by the bone conduction stimulation; and applying electrical stimulation to the subject at a range of levels; and receiving, and storing as compensation information, an electrical stimulation threshold level representative of a threshold level of the electrical stimulation at which the subject perceives sound by the electrical stimulation.

An eighth example is a method for generating compensation information for use in connection with a multi-mode hearing stimulation system including a bone conduction stimulation transducer positioned with respect to a head of a subject and at least two electrical stimulation electrodes (e.g., including a cathode and anode pair) positioned at spaced apart locations with respect to the head of the user. Embodiments comprise: applying bone conduction stimulation and electrical stimulation to the subject; receiving, and storing as compensation information, information representative of a direction from which the subject perceives the perception of sound produced by the bone conduction stimulation and the electrical stimulation.

A ninth example is a method for stimulating the perception of hearing in a subject. Embodiments comprise: receiving sound signals representative of multi-channel sound; generating multi-channel electrical stimulation signals based on the sound signals and configured to produce electrical signals causing stimulation of hearing perception in a subject, including lateralization of hearing perception, when coupled to at least two electrical stimulation electrodes positioned at spaced-apart locations with respect to a head of the subject; and generating audio stimulation signals based on the sound signals and configured to produce air conducted pressure wave sound in the subject when coupled to an audio transducer positioned with respect to an ear on the head of the subject.

Embodiments of the ninth example further comprise obtaining compensation information for use in connection with a multi-mode hearing stimulation system, comprising: concurrently applying the electrical stimulation and the pressure wave sound to the subject; and receiving, and storing as compensation information, information representative of a direction from which the subject perceived the perception of sound produced by the electrical stimulation and pressure wave sound.

In any or all embodiments of the ninth example, generating audio stimulation signals may comprise generating multi-channel audio stimulation signals configured to produce air conducted pressure wave sound, including lateralization, in the subject, when coupled to two or more audio transducers positioned at spaced-apart locations with respect to ears on the head of the subject.

Any or all embodiments of the ninth example may further comprise obtaining compensation information for use in connection with a multi-mode hearing stimulation system, comprising: concurrently applying the electrical stimulation and the pressure wave sound to the subject; and receiving, and storing as compensation information, information representative of a direction from which the subject perceived the perception of sound produced by the electrical stimulation and pressure wave sound.

A tenth example is a method for stimulating the perception of hearing in a subject. Embodiments comprise: receiving sound signals representative of multi-channel sound; generating bone conduction stimulation signals based on the sound signals and configured to produce vibrations causing stimulation of hearing perception in the subject, when coupled to at least one bone conduction stimulation transducer positioned with respect to the head of the subject; and generating audio stimulation signals based on the sound signals and configured to produce air conducted pressure wave sound in the subject when coupled to an audio transducer positioned with respect to an ear on the head of the subject.

Embodiments of the tenth example further comprise obtaining compensation information for use in connection with a multi-mode hearing stimulation system, comprising: concurrently applying the bone conduction stimulation and the pressure wave sound to the subject; and receiving, and storing as compensation information, information representative of a direction from which the subject perceived the perception of sound produced by the bone conduction stimulation and pressure wave sound.

In any or all embodiments of the tenth example, generating audio stimulation signals may comprise generating multi-channel audio stimulation signals configured to produce air conducted pressure wave sound, including lateralization, in the subject, when coupled to two or more audio transducers positioned at spaced-apart locations with respect to ears on the head of the subject.

Any or all embodiments of the tenth example may further comprise obtaining compensation information for use in connection with a multi-mode hearing stimulation system, comprising: concurrently applying the bone conduction stimulation and the pressure wave sound to the subject; and receiving, and storing as compensation information, information representative of a direction from which the subject perceived the perception of sound produced by the bone conduction stimulation and pressure wave sound.

Embodiments of an eleventh example include a method for stimulating the perception of hearing in a subject. The method comprises: receiving sound signals representative of multi-channel sound; generating multi-channel electrical stimulation signals based on the sound signals and configured to produce electrical signals causing electrical stimulation of hearing perception in a subject, including lateralization of hearing perception, when coupled to at least two electrical stimulation electrodes positioned at spaced-apart locations with respect to a head of the subject; and generating bone conduction stimulation signals based on the sound signals and configured to produce vibrations causing bone conduction stimulation of hearing perception in the subject, when coupled to at least one bone conduction stimulation transducer positioned with respect to the head of the subject.

Embodiments of the eleventh example may further comprise obtaining compensation information for use in connection with a multi-mode hearing stimulation system, comprising: concurrently applying the electrical stimulation and the bone conduction stimulation to the subject; and receiving, and storing as compensation information, information representative of a direction from which the subject perceived the perception of sound produced by the electrical stimulation and the bone conduction stimulation.

Any or all embodiments of the eleventh example may further comprise generating audio stimulation signals based on the sound signals and configured to produce air conducted pressure wave sound in the subject when coupled to an audio transducer positioned with respect to an ear on the head of the subject. Embodiments may further comprise obtaining compensation information for use in connection with a multi-mode hearing stimulation system, comprising: concurrently applying the electrical stimulation, the bone conduction stimulation and the pressure wave sound to the subject; and receiving, and storing as compensation information, information representative of a direction from which the subject perceived the perception of sound produced by the electrical stimulation, bone conduction stimulation and pressure wave sound.

In any or all embodiments of the eleventh example, generating audio stimulation signals comprises generating multi-channel audio stimulation signals configured to produce air conducted pressure wave sound, including lateralization, in the subject, when coupled to two or more audio transducers positioned at spaced-apart locations with respect to ears on the head of the subject. Embodiments further comprise obtaining compensation information for use in connection with a multi-mode hearing stimulation system, comprising: concurrently applying the electrical stimulation, the bone conduction stimulation and the pressure wave sound to the subject; and receiving, and storing as compensation information, information representative of a direction from which the subject perceived the perception of sound produced by the electrical stimulation, bone conduction stimulation and pressure wave sound.

It is to be understood that the above description is intended to be illustrative, and not restrictive. Many other embodiments will be apparent to those of skill in the art upon reading and understanding the above description. It is contemplated that features described in association with one embodiment are optionally employed in addition or as an alternative to features described in or associated with another embodiment. The scope of the invention should, therefore, be determined with reference to the appended claims, along with the full scope of equivalents to which such claims are entitled.

1. A method for stimulating the perception of hearing in a subject, comprising:
receiving sound signals representative of multi-channel sound;
generating multi-channel electrical stimulation signals based on the sound signals and configured to produce electrical signals causing electrical stimulation of hearing perception in a subject, including lateralization of hearing perception, when coupled to at least two electrical stimulation electrodes positioned at spaced-apart locations with respect to a head of the subject; and
generating bone conduction stimulation signals based on the sound signals and configured to produce vibrations causing bone conduction stimulation of hearing perception in the subject, when coupled to at least one bone conduction stimulation transducer positioned with respect to the head of the subject.

2. The method of claim 1, further comprising obtaining compensation information for use in connection with a multi-mode hearing stimulation system, comprising:
concurrently applying the electrical stimulation and the bone conduction stimulation to the subject; and
receiving, and storing as compensation information, information representative of a direction from which the subject perceived the perception of sound produced by the electrical stimulation and the bone conduction stimulation.

3. The method of claim 1, further comprising generating audio stimulation signals based on the sound signals and configured to produce air conducted pressure wave sound in the subject when coupled to an audio transducer positioned with respect to an ear on the head of the subject.

4. The method of claim 3, further comprising obtaining compensation information for use in connection with a multi-mode hearing stimulation system, comprising:
concurrently applying the electrical stimulation, the bone conduction stimulation and the pressure wave sound to the subject; and
receiving, and storing as compensation information, information representative of a direction from which the subject perceived the perception of sound produced by the electrical stimulation, bone conduction stimulation and pressure wave sound.

5. The method of claim 3, wherein generating audio stimulation signals comprises generating multi-channel audio stimulation signals configured to produce air conducted pressure wave sound, including lateralization, in the subject, when coupled to two or more audio transducers positioned at spaced-apart locations with respect to ears on the head of the subject.

6. The method of claim 5, further comprising obtaining compensation information for use in connection with a multi-mode hearing stimulation system, comprising:
concurrently applying the electrical stimulation, the bone conduction stimulation and the pressure wave sound to the subject; and
receiving, and storing as compensation information, information representative of a direction from which the subject perceived the perception of sound produced by the electrical stimulation, bone conduction stimulation and pressure wave sound.

7. A method for stimulating the perception of hearing in a subject, comprising:
receiving sound signals representative of multi-channel sound;
generating multi-channel electrical stimulation signals based on the sound signals and configured to produce electrical signals causing stimulation of hearing perception in a subject, including lateralization of hearing perception, when coupled to at least two electrical stimulation electrodes positioned at spaced-apart locations with respect to a head of the subject; and
generating audio stimulation signals based on the sound signals and configured to produce air conducted pressure wave sound in the subject when coupled to an audio transducer positioned with respect to an ear on the head of the subject.

8. The method of claim 7, further comprising obtaining compensation information for use in connection with a multi-mode hearing stimulation system, comprising:
concurrently applying the electrical stimulation and the pressure wave sound to the subject; and
receiving, and storing as compensation information, information representative of a direction from which the subject perceived the perception of sound produced by the electrical stimulation and pressure wave sound.

9. The method of claim 7, wherein generating audio stimulation signals comprises generating multi-channel audio stimulation signals configured to produce air conducted pressure wave sound, including lateralization, in the subject, when coupled to two or more audio transducers positioned at spaced-apart locations with respect to ears on the head of the subject.

10. The method of claim 9, further comprising obtaining compensation information for use in connection with a multi-mode hearing stimulation system, comprising:
concurrently applying the electrical stimulation and the pressure wave sound to the subject; and
receiving, and storing as compensation information, information representative of a direction from which the subject perceived the perception of sound produced by the electrical stimulation and pressure wave sound.

11. A method for stimulating the perception of hearing in a subject, comprising:
receiving sound signals representative of multi-channel sound;
generating bone conduction stimulation signals based on the sound signals and configured to produce vibrations causing stimulation of hearing perception in the subject, when coupled to at least one bone conduction stimulation transducer positioned with respect to the head of the subject; and
generating audio stimulation signals based on the sound signals and configured to produce air conducted pressure wave sound in the subject when coupled to an audio transducer positioned with respect to an ear on the head of the subject.

12. The method of claim 11, further comprising obtaining compensation information for use in connection with a multi-mode hearing stimulation system, comprising:
concurrently applying the bone conduction stimulation and the pressure wave sound to the subject; and
receiving, and storing as compensation information, information representative of a direction from which the subject perceived the perception of sound produced by the bone conduction stimulation and pressure wave sound.

13. The method of claim 11, wherein generating audio stimulation signals comprises generating multi-channel audio stimulation signals configured to produce air conducted pressure wave sound, including lateralization, in the subject, when coupled to two or more audio transducers positioned at spaced-apart locations with respect to ears on the head of the subject.

14. The method of claim 13, further comprising obtaining compensation information for use in connection with a multi-mode hearing stimulation system, comprising:
concurrently applying the bone conduction stimulation and the pressure wave sound to the subject; and
receiving, and storing as compensation information, information representative of a direction from which the subject perceived the perception of sound produced by the bone conduction stimulation and pressure wave sound.

15. The method of claim 1, wherein generating the multi-channel electrical stimulation signals comprises generating the multi-channel electrical stimulation signals including one or both of level or phase differences.

16. The method of claim 15, including generating the multi-channel electrical stimulation signals configured for first and second electrodes positioned adjacent right and left mastoids, respectively, of the subject (e.g., at 3:00 and 9:00 positions with respect to the head of the subject).

17. The method of claim 16, wherein receiving the sound signals comprises receiving signals representative of multi-channel sound from first and second microphones positioned adjacent right and left mastoids, respectively, of the subject (e.g., at 3:00 and 9:00 positions with respect to the head of the subject).

18. The method of claim 1, including generating the multi-channel electrical stimulation signals configured for at least two electrical stimulation electrodes positioned at 12:00 and 6:00 positions, respectively, with respect to the head of the subject.

19. The method of claim 18, wherein receiving the sound signals comprises receiving signals representative of multi-channel sound from two microphones positioned at 12:00 and 6:00 positions, respectively, with respect to the head of the subject.

20. The method of claim 1, including generating the multi-channel electrical stimulation signals configured for at least two electrical stimulation electrodes positioned at 1:30 and 7:30 positions, respectively, with respect to the head of the subject.

21. The method of claim 20, wherein receiving the sound signals comprises receiving signals representative of multi-channel sound from two microphones positioned at 1:30 and 7:30 positions, respectively, with respect to the head of the subject.

22. The method of claim 1, including generating the multi-channel electrical stimulation signals configured for at least two electrical stimulation electrodes positioned at 4:30 and 10:30 positions, respectively, with respect to the head of the subject.

23. The method of claim 22, wherein receiving the sound signals comprises receiving signals representative of multi-channel sound from two microphones positioned at 4:30 and 10:30 positions, respectively, with respect to the head of the subject.

24. The method of claim 1, wherein generating the bone conduction stimulation signals comprises generating bone conduction stimulation signals configured for a bone conduction transducer positioned along a median midline with respect to the head of the subject.

25. The method of claim 1, wherein generating the bone conduction stimulation signals comprises generating multi-channel bone conduction stimulation signals configured to produce vibrations by the bone conduction stimulation transducer causing stimulation of hearing perception, including lateralization of hearing perception in the subject, based on the sound signals.

26. The method of claim 25, wherein generating the multi-channel bone conduction stimulation signals comprises generating multi-channel bone conduction stimulation signals configured to produce vibrations by first and second bone conduction stimulation transducers positioned on opposite sides of a median midline with respect to the head of the subject.

27. The method of claim 25, wherein generating the multi-channel bone conduction signals includes generating multi-channel bone conduction signals including one or both of level or phase differences.

28. The method of claim 1, wherein (1) generating the electrical stimulation signals includes generating multi-channel electrical stimulation signals to produce electrical signals causing stimulation of hearing at frequencies greater than or equal to 8 KHz, and (2) generating the bone conduction stimulation signals includes generating bone conduction stimulation signals to produce vibrations causing stimulation of hearing at frequencies less than 8 KHz.

29. The method of claim 1, including generating the multi-channel electrical stimulation signals to produce electrical signals causing stimulation of hearing at a range of frequencies including frequencies greater than a range of frequencies of the hearing caused by the vibrations produced by the bone conduction stimulation signals.

30. The method of claim 1, wherein one or both of (1) generating the multi-channel electrical stimulation signals includes generating the multi-channel electrical stimulation signals based on the sound signals and electrical stimulation lateralization compensation information, wherein the electrical stimulation lateralization compensation information includes information characterizing one or both of location or level of sound perception of the subject based on one or more of (i) characteristics of the multi-channel electrical stimulation signals, or (ii) which of the at least two electrical stimulation electrodes the multi-channel electrical stimulation signals are coupled to, or (2) generating the bone conduction stimulation signals includes generating the bone conduction stimulation signals based on the sound signals and bone conduction lateralization compensation information, wherein the bone conduction lateralization compensation information includes information characterizing one or both of location or level of sound perception of the subject based on one or more of (iii) characteristics of the bone conduction stimulation signals, or (iv) which of the at least one bone conduction stimulation transducer the bone conduction stimulation signals are coupled to.
